(19) United States
(12) Patent Application Publication
(10) Pub. No.: US 2009/0141339 A1
(43) Pub. Date: Jun. 4, 2009

(54) OPTICAL MODULATOR, OPTICAL MODULATOR MODULE AND SCANNING DISPLAY APPARATUS INCLUDING THE SAME

(75) Inventors: Victor Yurlov, Suwon-si (KR); Sang-Kyeong Yun, Suwon-si (KR); Jong-Hyeong Song, Suwon-si (KR); In-Jae Yeo, Yongin-si (KR); Haeng-Seok Yang, Bucheon-si (KR); Anatoliy Lapchuk, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/325,988

(22) Filed: Dec. 1, 2008

(30) Foreign Application Priority Data
Dec. 3, 2007 (KR) 10-2007-0124566

(51) Int. Cl. G02F 1/29

(52) U.S. Cl. 359/318

(57) ABSTRACT

Disclosed are an optical modulator and an optical modulator module that can reduce a laser speckle. The optical modulator module can include an optical modulator, modulating an incident beam of light incident according to a driving signal and outputting the modulated beam of light; and a light transmissive substrate, placed in the optical modulator and formed with a phase control pattern, the incident beam of light and the outputted beam of light passing through the light transmissive substrate and the phase control pattern being formed in a part of a surface that is a light path of the incident beam of light and the outputted beam of light. Here, the phase control pattern, a central peak of an autocorrelation function can have a width that is smaller than a width of the phase control pattern, and a side lobe level is smaller than a level of the central peak.

### CROSS-REFERENCE TO RELATED PATENT APPLICATIONS

This application claims the benefit of Korean Patent Application No. 10-2007-0124566, filed on Dec. 3, 2007, in the Korean Intellectual Property Office, the disclosure of which is incorporated herein in its entirety by reference.

### BACKGROUND OF THE INVENTION

1. Field of the Invention

The present invention relates to an optical modulator, more specifically to an optical modulator and an optical modulator module that can reduce a laser speckle.

2. Background Art

The human eye has a limited resolution. When watching an object, the human eye quantizes the object into a plurality of points according to the resolution. For example, in case that the human eye watches the surface of a certain object placed at a distance of about 3 meter in front of the human eye, the human eye resolves the surface of the certain object into points having the diameter of 1 mm.

FIG. 1 illustrates how a human eye watches a diffuse surface. Referring to FIG. 1, if a laser beam of light 16 emitted from a laser source is projected on the diffuse surface 14, an image corresponding to a point 18 of the diffuse surface 14 is focused on a retina of the human eye 12. The shapes on the diffuse surface 14, the sizes of which are smaller than the point 18 are unable to be resolved by the human eye 12. The point 18 includes a plurality of scattering centers, which scatters the laser beam of light 16.

Since the laser beam of light 16 has the interference, the scattering centers create the interference on the human eye 12. The interference enables the human eye 12 to recognize the point 18 in the gray scale between the brightest point and the darkest point. Each scattering center becomes the centers of various light waves. Each light wave creates the conductive and/or destructive inference to determine a gray scale of the point 18.

For example, the point 18 becomes a bright point by the conductive inference of the light waves or a dark point by the destructive inference. This causes the human eye 12 to make particulate patterns on which bright, mid-bright and dark points are randomly patterned. The particulate pattern is referred to as a speckle.

Like the human eye 12 of FIG. 1, the same is also applied to a typical optical system. Accordingly, if the interference beam of light such as a laser beam of light is focused on a rough surface such as the diffuse surface 14, a speckle may be detected.

FIG. 2 is a picture including a granular pattern of bright, mid-bright and dark points. Since the speckle deteriorates the quality of a displayed image, the speckle is required to be reduced.

The kind of speckle shown in FIG. 2 may be reduced by superposing uncorrelated speckle patterns in the quantities of N. If the N uncorrelated speckle patterns have the same average intensity, a speckle reduction factor can be \sqrt{N}. If the N uncorrelated speckle patterns have the different average intensities, the speckle reduction factor may be equal to or smaller than \sqrt{N}. Also, the uncorrelated speckle pattern can be acquired by spatial superposition, time average, frequency or partial wave.

FIG. 3 is a simple plan view showing the conventional display apparatus for reducing a laser speckle.

A laser source 305 emits a laser beam of light 372. An illumination optical apparatus 310 including a divergence lens 312, a collimation lens 314 and a cylinder lens 316 concentrates the laser beam of light 372 on an optical modulator 320. A modulation beam of light modulated by the optical modulator 320 is projected on a screen 360 through a Schlieren optical device 330 and a projection device 350. Herein, the Schlieren optical device 330 includes a first release lens 332, a second release lens 336 and a Schlieren stop 334, and the projection device 350, which has a two-dimensional rectangular arrangement to generate a phase shift by repeated scanning operations, includes a diffuser 340, a projection lens 352 and a scanning mirror 354.

Here, a laser speckle is reduced through the diffuser 340 having a two-dimensional rectangular arrangement according to the N uncorrelated speckle patterns in order to generate a phase shift in repeated scanning operations. The diffuser 340 is required to be separately equipped in the conventional display apparatus 300. Also, an intermediate image plane is necessarily needed. This results in the increased and complex overall volume of the display apparatus 300. Accordingly, it is difficult to employ the conventional display apparatus 300 for a small sized projector.

### SUMMARY OF THE INVENTION

The present invention provides an optical modulator and an optical modulator module that can allow a phase control pattern capable of reducing a laser speckle without an additional device (i.e. the increase of volume) to be formed on the optical modulator or the optical modulator module.

The present invention also provides an optical modulator and an optical modulator module that can prevent the quality of an image from being deteriorated by reducing a laser speckle.

The present invention also provides an optical modulator and an optical modulator module that can be used for a small sized optical system such as a mobile optical system.

An aspect of present invention features an optical modulator module including an optical modulator, modulating an incident beam of light incident according to a driving signal and outputting the modulated beam of light; and a light transmissive substrate, placed in the optical modulator and formed with a phase control pattern, the incident beam of light and the outputted beam of light passing through the light transmissive substrate and the phase control pattern being formed in a part of a surface that is a light path of the incident beam of light and the outputted beam of light. Here, in the phase control pattern, a central peak of an autocorrelation function can have a width w that is smaller than a width T of the phase control pattern, and a side lobe level Aₛ is smaller than a level A(0) of the central peak.

Here, the phase control pattern can satisfy formulas |Aₛ/A(0)|²<<1 and w/T<<1.

The phase control pattern can be engraved in an embossed form with a height of compound Barker code sequence pattern. Alternatively, the phase control pattern can be engraved in a depressed form with a depth of compound Barker code sequence pattern.

The phase control pattern can be induces a relative phase shift of zero radian or π radian.

Another aspect of present invention features an optical modulator including a substrate; an insulation layer, placed in the substrate; a structure layer, having a center part which is placed away from the insulation layer at a predetermined interval, and having a surface in which an upper mirror is formed, a first phase control pattern being formed in the center part; and a piezoelectric driving element, placed in opposite side parts of the structure layer and allowing the center part of the structure layer to move up and down. Here, in the first phase control pattern, a central peak of an autocorrelation function can have a width w that is smaller than a width T of the phase control pattern, and a side lobe level Aₛ is smaller than a level A(0) of the central peak.

The first phase control pattern can satisfy formulas |Aₛ/A(0)|²<<1 and w/T<<1.

The first phase control pattern can be engraved in an embossed form with a height of compound Barker code sequence pattern or in a depressed form with a depth of compound Barker code sequence pattern.

The first phase control pattern can induce a relative phase shift of zero radian or π radian.

Also, at least one slit can be formed in a lengthwise direction at the center part of the structure layer, and the insulation layer can have a surface in which a lower mirror is formed and a second phase control pattern can be formed at a lower part of the first phase control pattern.

In the second phase control pattern, a central peak of an autocorrelation function can have a width w that is smaller than a width T of the phase control pattern, and a side lobe level Aₛ can be smaller than a level A(0) of the central peak. The second phase control pattern can satisfy formulas |Aₛ/A(0)|²<<1 and w/T<<1.

The second phase control pattern can be engraved in an embossed form with a height of compound Barker code sequence pattern or in a depressed form with a depth of compound Barker code sequence pattern.

The second phase control pattern can induce a relative phase shift of zero radian or π radian.

The first phase control pattern and the second phase control pattern can have identical shapes.

Another aspect of present invention features a scanning display apparatus including a light source, emitting an incident beam of light; an optical modulator module, modulating the incident beam of light and outputting the modulated beam of light; and a scanning mirror, scanning the outputted beam of light on a screen. Here, the optical modulator module comprises a light transmissive substrate, placed in the optical modulator and formed with a phase control pattern, the incident beam of light and the outputted beam of light passing through the light transmissive substrate and the phase control pattern being formed in a part of a surface that is a light path of the incident beam of light and the outputted beam of light. At this time, in the phase control pattern, a central peak of an autocorrelation function has a width w that is smaller than a width T of the phase control pattern, and a side lobe level Aₛ is smaller than a level A(0) of the central peak.

Another aspect of present invention features a scanning display apparatus including a light source, emitting an incident beam of light; an optical modulator module, modulating the incident beam of light and outputting the modulated beam of light; and a scanning mirror, scanning the outputted beam of light on a screen Here, an optical modulator comprises a substrate; an insulation layer, placed in the substrate; a structure layer, having a center part which is placed away from the insulation layer at a predetermined interval, and having a surface in which an upper mirror is formed, a first phase control pattern being formed in the center part; and a piezoelectric driving element, placed in opposite side parts of the structure layer and allowing the center part of the structure layer to move up and down. At this time, in the first phase control pattern, a central peak of an autocorrelation function has a width w that is smaller than a width T of the phase control pattern, and a side lobe level Aₛ is smaller than a level A(0) of the central peak.

### BRIEF DESCRIPTION OF THE DRAWINGS

These and other features, aspects and advantages of the present invention will become better understood with regard to the following description, appended Claims and accompanying drawings where:

FIG. 1 illustrates how a human eye watches a diffuse surface;

FIG. 2 is a picture including a granular pattern of bright, mid-bright and dark points;

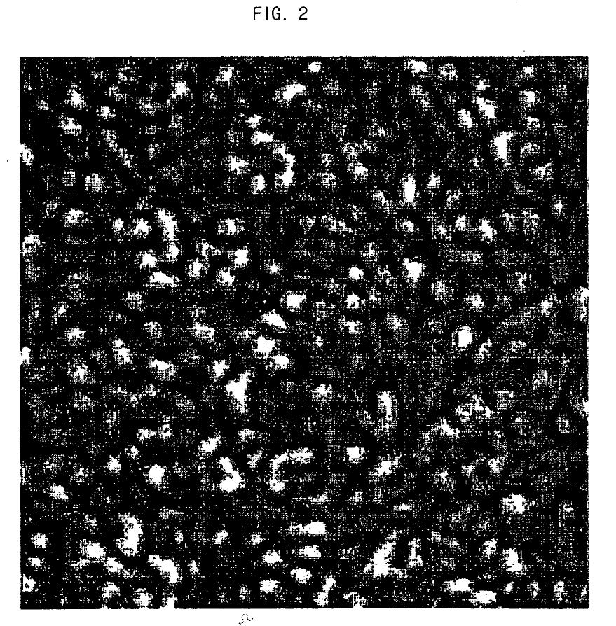

FIG. 3 is a simple plan view showing the conventional display apparatus for reducing a laser speckle;

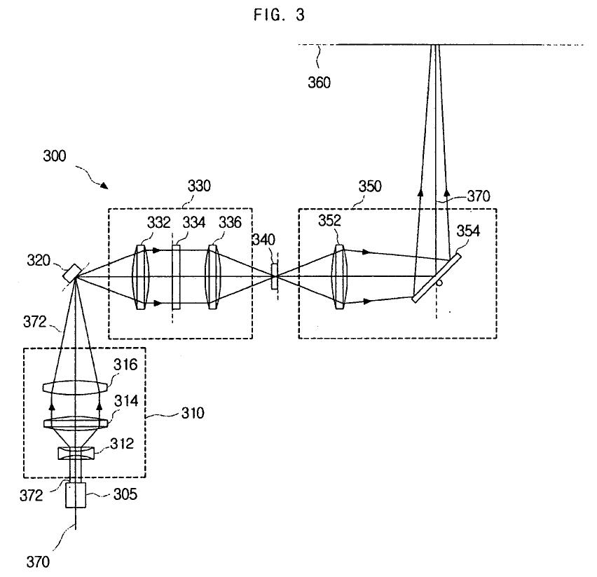

FIG. 4 is a plan view showing a display apparatus in an embodiment of the present invention;

FIG. 5 is a side view showing the display apparatus of FIG. 4, shown along the optical axis;

FIG. 6 is a partial perspective view showing an optical modulator included in a display apparatus in accordance with an embodiment of the present invention;

FIG. 7 is a sectional view showing an optical modulator module in which a phase control pattern is formed on a light transmissive substrate in accordance with an embodiment of the present invention;

FIG. 8 shows an example of a Barker code sequence pattern;

FIG. 9 shows a basic Barker code sequence having the length of 7;

FIG. 10 shows a compound Barker code sequence having the length of 7×7;

FIG. 11 is a squre mosule graph of a autocorrelation function of a compound Barker code sequence having the length of 7×7; and

FIG. 12 is a perspective view showing an optical modulator having a phase control pattern in accordance with another embodiment of the present invention.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

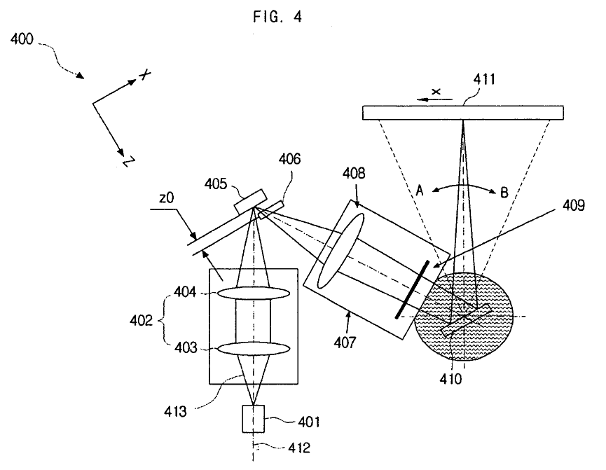

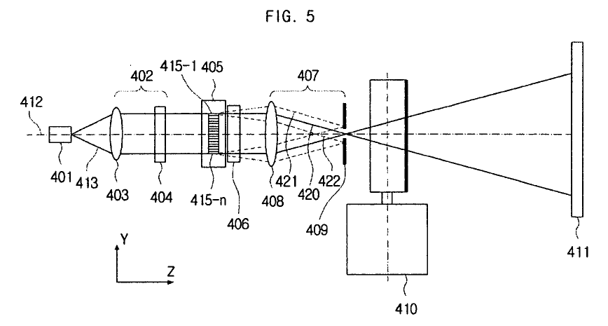

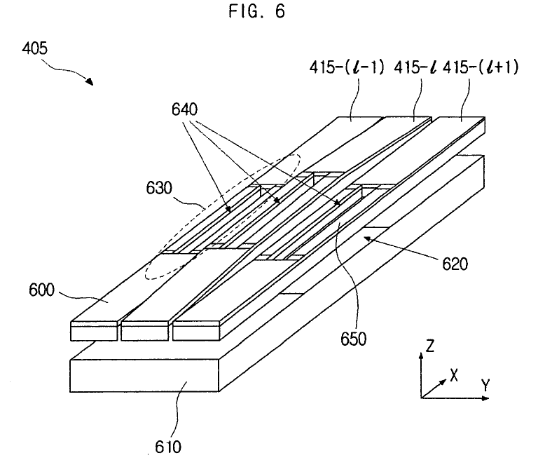

FIG. 4 is a plan view showing a display apparatus in an embodiment of the present invention, and FIG. 5 is a side view showing the display apparatus of FIG. 4, shown along the optical axis. FIG. 6 is a partial perspective view showing an optical modulator included in a display apparatus in accordance with an embodiment of the present invention.

The display apparatus 400 can include a light source 401, an illumination optical system 402, an optical modulator 405, a projection optical system 407 and a scanning mirror 410. It shall be easily recognized by any person of ordinary skill in the art that a typical display apparatus includes the illumination optical system 402 and the projection optical system 407. Here, the display apparatus 400 can be a scanning display apparatus that forms a two or three-dimensional image by allowing a one-dimensional linear beam of light to be scanned in a predetermined direction by the scanning mirror 410.

The light source 401 can emit an incident beam of light 413, which is projected on the optical modulator 405 along an optical axis 412 through the illumination optical system 402. The present invention is to use the interference of a laser beam of light and to reduce a corresponding laser speckle. Herein, the light source 410 can be a laser source or a laser diode that emits a laser beam of light.

The illumination optical system 402 can include a condenser 403, collecting a beam of light 413 emitted from the light source 401 in parallel with the optical axis 412, and a cylinder lens 404, concentrating the beam of light 413 collected by the condenser 403 on the mirrors of the optical modulator 405. Alternatively, it shall be evident to any person of ordinary skill in the art that the beam of light 413 can be transferred to the cylinder lens 404 by using a divergence lens and a collimation lens, which are not shown, instead of the condenser 403.

The illumination optical system 402 can concentrate the beam of light 403 emitted from the light source 401 in a form of one-dimensional linear beam of light on the optical modulator 405. Here, the beam of light 413 incident on the optical modulator 405 can have the incident angle that allows a reflection beam and diffraction beam of light to reach to a Schlieren stop 409 of the projection optical system 407.

It shall be evident to any person of ordinary skill in the art that other optical systems can project the incident beam of light 413 on the optical modulator 405, instead of the illumination optical system 402. Also, it shall be evident to any person of ordinary skill in the art that the lens used in the present invention is not limited to a single structure lens and a composition lens or a reflective optical element can be used.

In the optical modulator 405, a plurality of ribbons 415-1, 415-2, . . . and 415-n having each mirror layer can be linearly arranged according to a focal line (i.e. Y axis) of the cylinder lens 404. Here, n is a natural number and equals to or larger than 2. The optical modulator 405 can modulate an incident beam of light by moving each ribbon 415-1, 415-2, . . . and 415-n in an upper or lower direction (i.e. a z-axis direction) according to an electric signal of an optical modulator driving circuit (not shown).

Referring to FIG. 6, the optical modulator 405 can include a plurality of ribbons 415-1, 415-2, . . . and 415-n. In FIG. 6, the description is focused on a (m−1)^{th} 415-(m−1), a m^{th} 415-m, a (m+1)^{th} 415 (m+1). Here, m<n.

The optical modulator 405 can include an insulation layer 610, placed on the substrate (not shown), a structure layer 600, having a center part 630 which is placed away from the insulation layer 610 at a predetermined interval, and a piezoelectric driving element (not shown), placed in opposite side parts of the structure layer 600 and allowing the center part 630 of the structure layer 600 to move up and down. The structure layer 600 can be formed with an upper mirror having a surface including the center part 630. Here, the surface can have the light reflection characteristic. The ribbon 415, which has a lengthwise shape in a direction, can include the structure layer 600 and the upper mirror 650.

In case that no slit is formed at the center part of the ribbon 415, at least one ribbon 415 can be collected in order to deal with one pixel. The plurality of ribbons 415 can move up and down according to a power supplied to the piezoelectric driving element (which is changed according to an electric signal of the optical modulator driving circuit).

When the plurality of ribbons 415 are maintaining a constant height, if a first power supplied to even-numbered ribbons allows the even-numbered ribbons to move up or down, the path difference may occur between a first reflection beam of light reflected from the even-numbered ribbons and a second reflection beam of light from the odd-numbered ribbons, to thereby create the diffraction (or interference). This makes it possible to modulate the intensity of beam, which can represent the gray scale of each pixel of an image.

If at least one slit 640 is formed at the center part 630 of the ribbon 415 (refer to FIG. 6), at least one or two ribbons can deal with one pixel of an image. The slit 640 can be a hole having a rectangular shape in the lengthwise direction of the ribbon 415 (i.e. an X-axis of FIG. 6).

At this time, a lower mirror 620 having the light reflection characteristic can be required to be formed on a surface of the insulation layer 610. Adjusting the power supplied to the piezoelectric driving element can allow at least one or two ribbons to simultaneously move up or down. This can make it possible to adjust the distance between the upper mirror 650 on the surface of the ribbon 415 and the lower mirror 620 of the insulation layer 610. The path difference may occur between a third reflection beam of light reflected from the upper mirror 650 and a fourth reflection beam of light reflected from the lower mirror 620, to thereby create the diffraction (or interference).

The gray scale of one pixel can be represented by using the path difference between each reflection beam of light in both cases of the ribbon 415 having the slit 640 and no slit. By the diffraction (or interference) principle, each reflection beam of light can form diffraction beams of light 421 and 422 of +1^{st} and −1^{st} diffraction orders D+1 and D−1 as well as a 0^{th}-order diffraction beam of light 420. The below description is focused on the case that the Schlieren stop 409 included in the below-described projection optical system 407 allows the 0^{th}-order diffraction beam of light 420 to proceed and the +1^{st} and −1^{st}-order diffraction beams of light to stop.

However, it shall be evident to any person of ordinary skill in the art that the Schlieren stop 409 can allow the 0^{th}-order diffraction beam of light 420 to stop and the +1^{st} and −1^{st}-order diffraction beams 421 and 422 of light to proceed. Also, it shall be evident to any person of ordinary skill in the art that a driving device operated by an electrostatic method can be alternatively used in order to move the ribbon 415 up and down, instead of the piezoelectric driving element.

The optical modulator 405 can modulate an incident beam of light and output the modulated beam of light in order to allow at least one or two ribbons 415 to represent the gray scale of one pixel of an image. As described above, the modulated beam of light can include the diffraction beam of light such as the 0^{th}-order diffraction beam of light 420, the +1^{st}-order diffraction beams 421 and the −1^{st}-order diffraction beam 422. The optical modulator 405, as described in FIG. 5 and FIG. 6, can allow a one-dimensional linear image to be represented by the plurality of ribbons in parallel with respect to the Y-axis direction.

At a point of time, the optical modulator 405 can represent a gray scale of any one (e.g. a vertical scanning line or a horizontal scanning device) of the one-dimensional linear image constituting a two-dimensional image. The scanning mirror 410 can display the pertinent one-dimensional linear image on a point of the screen 411. According to a scanning frequency, the optical modulator 405 can modulate a plurality of one-dimensional linear images and the scanning mirror 410 can scan the modulated one-dimensional linear images in a predetermined direction (e.g. one direction or two directions), in order to display the whole two-dimensional image.

The beams of light 420, 421 and 422 outputted from the optical, modulator 405 can pass through the projection optical system 407 before being transferred to the scanning mirror 410. The projection optical system 407 can include the projection lens 408 and the Schlieren stop 409. The projection lens 408 can spread the outputted beams of light 420, 421 and 422, which are one-dimensional linear images, in a form of two-dimensional spatial image (i.e. a form in which the one-dimensional linear image is spread left and right) before being finally projected on the screen 411 as a one-dimensional linear image through the scanning mirror 410. The Schlieren stop 409 can allow a certain diffraction beam of light selected according to the diffraction order to pass through the Schlieren stop 409.

The galvano mirror can return to the original place by a first scanning movement A and project the outputted one-dimensional linear images on the screen 411 by a second scanning movement B, or vice versa. The continuous two-dimensional planar image frame can be displayed by the first scanning movement A and the second scanning movement B.

Also, it shall be evident to any person of ordinary skill in the art that the outputted beams of light can be projected by allowing a polygon mirror (not shown) or a rotation bar (not shown) to be placed instead of the galvano mirror and to rotate in a direction in order to project the outputted beams of light on the screen 411. In the present invention, the galvano mirror, the polygon mirror or the rotation bar can be collectively referred to as the scanning mirror.

A phase control pattern 406 can be formed on an upper mirror of the optical modulator 405 or on a light transmissive substrate of an optical modulator module including the optical modulator 405. The phase control pattern 406 can reduce a laser speckle. Hereinafter, the apparatus and method of reducing a laser speckle through the adjustment of a speckle phase will be described in detail.

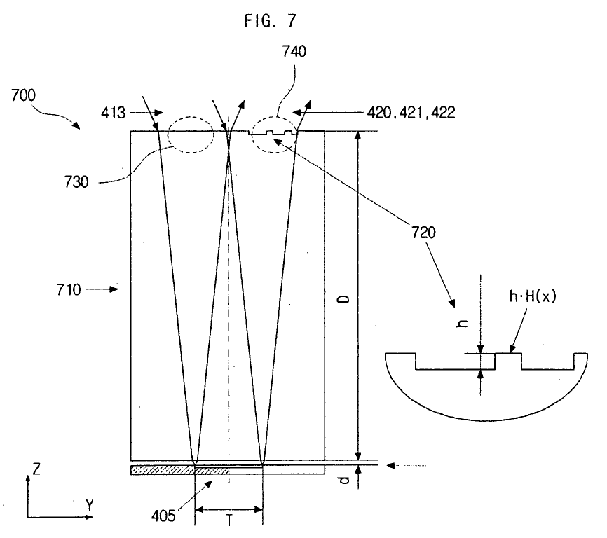

FIG. 7 is a sectional view showing an optical modulator module in which a phase control pattern is formed on a light transmissive substrate in accordance with an embodiment of the present invention.

The optical modulator module 700 can include the optical modulator 405 and a light transmissive substrate 710.

The light transmissive substrate 710 can be equipped in an upper part of the optical modulator 405 in order to allow a beam of light to be incident on the optical modulator 405 and the modulated beam of light to be outputted. In particular, the light transmissive substrate 710 can be placed on a surface related to the optical modulation (i.e. the surface on which the upper mirror 650 is placed) among opposite surfaces of the optical modulator 405 in order to pass through the incident beam of light 413 and the outputted beams of light 420, 421 and 422).

Since the optical modulator 405 is a kind of micro electro mechanical system (MEMS) performing a mechanical movement according to micro electricity (or voltage or current), the optical modulator 405 can be modularized to minimize the affect caused by the external environments such as temperature, humidity, particulate matter, vibration and impact. The ribbon 415 performing the mechanical movement in the optical modulator 405 can undergo a hermetical process by using the light transmissive substrate 710 through which the incident beam of light 413 and the outputted beams of light 420, 421 and 422 can pass, which is not shown in FIG. 7.

The light transmissive substrate 710 can be mode of a material, which 99 percent or more of light penetrates, such as glass.

Referring to FIG. 7, a phase control pattern 720 can be formed on a part 740 of the surface, which is the light path of the outputted beams of light 420, 421 and 422, among the surfaces of the light transmissive substrate 710.

The phase control pattern 720, which is engraved in a depressed form, can have two depths (e.g. 0 and h). According to each depth, the outputted beams of light 420, 421 and 422 can induce a first relative phase shift of zero radian or a second relative phase shift of π radian. Alternatively, the phase control pattern 720 can be engraved in an embossed form with two depths (e.g. 0 and h) unlike FIG. 7. According to each depth, the outputted beams of light 420, 421 and 422 can induce a first relative phase shift of zero radian or a second relative phase shift of π radian.

Instead of the optical path of the outputted beams of light 420, 421 and 422, the phase control pattern 720 can be formed on a part 730 of the surface, which is the light path of the incident beam of light 413. This may deteriorate the contrast radio of the display apparatus in shown in FIG. 4 and FIG. 5. Accordingly, it can be preferable that the phase control pattern 720 can be formed on the part 740 of the surface, which is the light path of the outputted beams of light 420, 421 and 422, of the light transmissive substrate 710.

The distance from the ribbon surface of the optical modulator 405 to the phase control pattern 720 z₀ (i.e. d+D) can satisfy the following formula 1.

$${z}_{0} \leq \frac{{T}^{2}}{λ} + D \frac{{n}_{0} - 1}{{n}_{0}} \qquad [ Formula 1 ]$$

Here, z₀>D or the thickness of the light transmissive substrate 710 can satisfy the following formula 2.

$$D \leq {n}_{0} ( \frac{{T}^{2}}{λ} - d ) \qquad [ Formula 2 ]$$

Here, d refers to the distance between an upper surface of the optical modulator 405 and a lower surface of the light transmissive substrate 710.

Also, T refers to the size of one pixel in a beam width or X axis, which is the ribbon pitch, and λ refers to the wavelength of beam.

In case that d<<D, the distance d between an upper surface of the optical modulator 405 may not be considered. In this case, the thickness of the light transmissive substrate 710 can be evaluated by the following formula.

$$D \leq {n}_{0} \frac{{T}^{2}}{λ}$$

The phase control pattern 720 can be required to satisfy the following formulas 3 and 4.

|Aₛ/A(0)|²<<1 [Formula 3]

w/T<<1 [Formula 4]

Here, As refers to the maximum side lobe amplitude, and A(0) refers to the central peak amplitude. w refers to the central peak width, and T refers to the total pattern width.

A(x), which is the autocorrelation function of the phase control function H(x), can allow a squared module to have the narrow central peak and a relative small low side lobe level. The autocorrelation function A(x) can be represented as the following formula 5.

A(x)=∫H(x−v)H*(v)dv [Formula 5]

The phase control function H(x) can be normalized.

The complex transparency t(x) can be represented as the following formula 6.

t(x)=exp {j[n₀·h·H(x)·2π/λ]} [Formula 6]

Here, j=\sqrt{−1}, and nₒ refers to the refractive index of the board in which the phase control pattern 720 is formed. h refers to the maximum height (or depth) of the phase control pattern 720 and 0<H(x)<1. λ refers to the wavelength of beam. Here, the phase control function H(x) can be a Barker code, a chirp signal and an M sequence.

The effect of reducing a laser speckle will be theoretically described by using a speckle contrast ratio. The speckle contrast ratio C can be evaluated by using the following formula 7.

$$C = \frac{{σ}_{I}}{〈 I 〉} = \frac{\sqrt{〈 {I}^{2} 〉 - {〈 I 〉}^{2}}}{〈 I 〉} \qquad [ Formula 7 ]$$

Here, <I> refers to the average value of light intensity in a speckle pattern, and σ_{I}, which refers to the standard deviation of light intensity, satisfies σ_{I}=\sqrt{ [symbol]I² [symbol] − [symbol] I [symbol] ²}. The domain in which the everage value is computed includes the whole screen.

It is assumed that the speckle pattern G(x) is stationary and ergodic, so the average with respect to the X-axis of a spatial coordinate is the same as the actual average of ensemble of realization.

Finding parameters in the formula 7 can be performed by considering one resolving factor (i.e. eye pixel) by the human eye on the screen and its statistical property. Since the speckle pattern is assumed to be stationary, an eye pixel can be considered as the reference. Hereinafter, pixels can be used in the center point (x=0) of the screen for the convenience of computation.

<I> can be defined as an expected value, and <I>² can be defined by the following formula 8.

$${〈 I 〉}^{2} = {〈 G ( x ) 〉}^{2} = {{E}_{0}^{2} ( G 0 \int \int f ( {x}_{1} - {x}_{2} ) A ( {x}_{1} - {x}_{2} ) Sin c [ \frac{2 π}{D} {x}_{1} ] Sin c [ \frac{2 π}{D} {x}_{2} ] {e}^{- j k \frac{{x}_{1}^{2} - {x}_{2}^{2}}{2 a}} d {x}_{1} d {x}_{2} )}^{2} \qquad [ Formula 8 ]$$

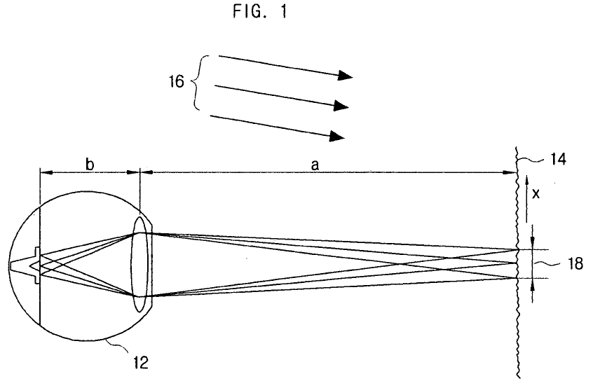

Here, E₀ refers to the amplitude of an electric (or magnetic) field of a beam of light incident on the screen. G0 refers to the constant coefficient, and x₁ and x₂ refer the horizontal coordinates. a refers to the crystalline lens object distance between the screen of FIG. 1 and the human eye.

The autocorrelation function of the screen modulation coefficient r(x), f(x₁−x₂)= [symbol] r(x₁)r*(x₂) [symbol] , can be satisfied. It is assumed that the screen micro-roughness correlation length χ is substantially very smaller than the central peak width ε of the autocorrelation function A(x) and the size D of the resolving factor of the screen.

The autocorrelation function of screen modulation f(x) can be R δ(x). Here, R=|r(x)|² and R refers to the power modulation index.

$$r ( x ) = β ( x ) exp [ jψ ( x ) ] and$$

$$ψ ( x ) = \{ \begin{matrix}2 {kh}_{s} ( x ) & \text{-} for direct projection screen \\ ( n - 1 ) {kh}_{s} ( x ) & \text{-} for rear projection screen\end{matrix}$$

Here, 0<β(x)<1, and β(x) refers to the amplitude of the screen modulation coefficient r(x). ψ(x) refers to the random phase shift provided to the screen micro-roughness relief h(x).

k, which refers to the wave-number, is 2π/λ. hₛ(x) refers to the relief height or intaglio depth of screen micro-roughness.

If the following formula is applied to the formula 8, the formula 8 can be represented as the formula 9.

$${\int }_{- ∞}^{∞} Sin {c}^{2} ( \frac{2 π}{D} x ) d x = \frac{D}{2 π} {\int }_{- ∞}^{∞} Sin {c}^{2} ( x ) d x = \frac{D}{2} \\ {〈 I 〉}^{2} = \frac{1}{4} {E}_{0}^{2} {R}^{2} G {0}^{2} {A}^{2} ( 0 ) {D}^{2} \qquad [ Formula 9 ]$$

In the formula 7, <I²> can be represented as the following formula 10.

$$\begin{matrix}{〈 I 〉}^{2} = 〈 {\{ {E}_{0}^{2} G 0 \int \int r ( {x}_{1} ) r * ( {x}_{2} ) Sin c [ \frac{2 π}{D} ( x + {x}_{1} ) ] \\ Sin c [ \frac{2 π}{D} ( x + {x}_{2} ) ] {e}^{- j k \frac{{x}_{1}^{2} - {x}_{2}^{2}}{2 a}} A ( {x}_{1} - {x}_{2} ) d {x}_{1} d {x}_{2} \}}^{2} 〉 = {E}_{0}^{4} G {0}^{2} \int \int \int \int F ( {x}_{1} , {x}_{2} , {x}_{3} , {x}_{4} ) A ( {x}_{1} - {x}_{2} ) A ( {x}_{3} - {x}_{4} ) Sin c [ \frac{2 π}{D} {x}_{1} ] Sin c [ \frac{2 π}{D} {x}_{2} ] \times Sin c [ \frac{2 π}{D} {x}_{3} ] Sin c [ \frac{2 π}{D} {x}_{4} ] {e}^{- j k \frac{{x}_{1}^{2} - {x}_{2}^{2} + {x}_{3}^{2} - {x}_{4}^{2}}{2 a}} d {x}_{1} d {x}_{2} d {x}_{3} d {x}_{4} & [ Formula 10 ]\end{matrix}$$

Here F(x₁,x₂,x₃,x₄)= [symbol] r(x₁)r*(x₂)r(x₃)r*(x₄) [symbol] . considering the narrow autocorrelation property, it is recognized that the function F may not be zero in three cases.
(a) In case that x₁=x₂ . . . x₃=x₄,

F1= [symbol] |r(x₁)|² [symbol] |r(x₃)|² [symbol] =R² (All cases without x₁=x₃)
(b) In case that x₂=x₃ and x₁=x₄,

F2= [symbol] r(x₂)|² [symbol] r(x₄)|² [symbol] =R² (All cases without x₂=x₄)
(c) In case that x₁=x₂=x₃=x₄,

F3= [symbol] (|r(x)|²)² [symbol] =σᵣ_{²}²+ [symbol] |r(x)|² [symbol] ²=2R².

Here, since r(x) is the random coefficient defining the amplitude and phase of a scattered beam of light, it is considered that the function F may be required to conform to the statistic of random walk generating a typical speckle pattern. Accordingly, |r(x)|² may be required to be a negative exponential density function, and the variance, which is the square of the standard deviation, may be equal to the square of the average as shown in the following formula.

σᵣ_{²}²= [symbol] (|r(x)|²)² [symbol] − [symbol] |r(x)|² [symbol] ²= [symbol] |r(x)|² [symbol] ²=R²

Now, the function F can be defined as the following formula 11.

$$F ( {x}_{1} , {x}_{2} , {x}_{3} , {x}_{4} ) = {R}^{2} δ ( {x}_{1} - {x}_{2} ) δ ( {x}_{3} - {x}_{4} ) [ 1 - δ ( {x}_{1} - {x}_{3} ) ] + {R}^{2} δ ( {x}_{2} - {x}_{3} ) δ ( {x}_{1} - {x}_{4} ) [ 1 - δ ( {x}_{2} - {x}_{4} ) ] + 2 {R}^{2} δ ( {x}_{1} - {x}_{2} ) δ ( {x}_{3} - {x}_{4} ) δ ( {x}_{1} - {x}_{3} ) = {R}^{2} [ δ ( {x}_{1} - {x}_{2} ) δ ( {x}_{3} - {x}_{4} ) + ( {x}_{2} - {x}_{3} ) δ ( {x}_{1} - {x}_{4} ) ] \qquad [ Formula 11 ]$$

Here, it is considered that

δ(x₁−x₂)δ(x₃−x₄)δ(x₁−x₃)=δ(x₂−x₃)δ(x₁−x₄)δ(x₂−x₄).

The formula 12 can be evaluated by subtracting the formula 10 from the formula 11.

[symbol]

=I² [symbol] In1+In2 [Formula 12]

Here, below are In1 and In2.

$$In 1 = {R}^{2} {E}_{0}^{4} G {0}^{2} \int \int \int \int δ ( {x}_{1} - {x}_{2} ) δ ( {x}_{3} - {x}_{4} ) A ( {x}_{1} - {x}_{2} ) A ( {x}_{3} - {x}_{4} ) Sin c [ \frac{2 π}{D} {x}_{1} ] Sin c [ \frac{2 π}{D} {x}_{2} ] \times Sin c [ \frac{2 π}{D} {x}_{3} ] Sin c [ \frac{2 π}{D} {x}_{4} ] {e}^{- j k \frac{{x}_{1}^{2} - {x}_{2}^{2} + {x}_{3}^{2} - {x}_{4}^{2}}{2 a}} d {x}_{1} d {x}_{2} d {x}_{3} d x = {R}^{2} {E}_{0}^{4} G {{{0}^{2} [ A ( 0 ) ]}^{2} [ {\int }_{- ∞}^{∞} Sin {c}^{2} ( \frac{2 π}{D} {x}_{2} ) d x ]}^{2} = {R}^{2} {E}_{0}^{4} G {{0}^{2} [ A ( 0 ) \frac{D}{2} ]}^{2} = {〈 I 〉}^{2}$$

$$In 2 = {R}^{2} {E}_{0}^{4} G {0}^{2} \int \int \int \int δ ( {x}_{2} - {x}_{3} ) δ ( {x}_{1} - {x}_{4} ) A ( {x}_{1} - {x}_{2} ) A ( {x}_{3} - {x}_{4} ) Sin c [ \frac{2 π}{D} {x}_{1} ] Sin c [ \frac{2 π}{D} {x}_{2} ] \times Sin c [ \frac{2 π}{D} {x}_{3} ] Sin c [ \frac{2 π}{D} {x}_{4} ] {e}^{- j k \frac{{x}_{1}^{2} - {x}_{2}^{2} + {x}_{3}^{2} - {x}_{4}^{2}}{2 a}} d {x}_{1} d {x}_{3} d {x}_{3} d {x}_{4} = {R}^{2} {E}_{0}^{4} G {0}^{2} \int \int {\vert A ( {x}_{3} - {x}_{4} ) \vert}^{2} Sin {c}^{2} [ \frac{2 π}{D} {x}_{3} ] Sin {c}^{2} [ \frac{2 π}{D} {x}_{4} ] d {x}_{3} d {x}_{4}$$

Here, that A(x₄−x₃)=A*(x₃−x₄) can be used.

Referring to the formula 7, the contrast ratio C can be evaluated as the following formula 13.

$$C = \sqrt{\frac{\int \int {\vert A ( {x}_{3} - {x}_{4} ) \vert}^{2} Sin {c}^{2} [ \frac{2 π}{D} {x}_{3} ] Sin {c}^{2} [ \frac{2 π}{D} {x}_{4} ] d {x}_{3} d {x}_{4}}{{{A}^{2} ( 0 ) [ \int Sin {c}^{2} [ \frac{2 π}{D} x ] d x ]}^{2}}} \qquad [ Formula 13 ]$$

If it is assumed that y=x₃−x₄ and u=x₄, the contrast ratio C can be represented as the following formula 14.

$$\int \int {\vert A ( {x}_{3} - {x}_{4} ) \vert}^{2} Sin {c}^{2} [ \frac{2 π}{D} {x}_{3} ] Sin {c}^{2} [ \frac{2 π}{D} {x}_{4} ] d {x}_{3} d {x}_{4} = {\int }_{- ∞}^{∞} d v {\int }_{- ∞}^{∞} {\vert A ( y ) \vert}^{2} Sin {c}^{2} [ \frac{2 π}{D} ( y + v ) ] Sin {c}^{2} [ \frac{2 π}{D} v ] d y = {\int }_{- ∞}^{∞} {\vert A ( y ) \vert}^{2} d y {\int }_{- ∞}^{∞} Sin {c}^{2} [ \frac{2 π}{D} ( y + v ) ] Sin {c}^{2} [ \frac{2 π}{D} v ] d v = {D}^{2} {\int }_{- ∞}^{∞} {\vert A ( Dv ) \vert}^{2} Q ( v ) d v \\ Here , Q ( v ) = {\int }_{- ∞}^{∞} Sin {c}^{2} [ 2 π ( v + x ) ] Sin {c}^{2} ( 2 π x ) d x , = \frac{1}{8 {π}^{2}} ( \frac{1 - Sin c ( 4 π v )}{{v}^{2}} ) . \qquad [ Formula 14 ]$$

From the formulas 13 and 14, the contrast ratio of the one-dimensional scanning display apparatus can be represented in a simple form as the following formula 15.

$${C}^{2} = 4 {\int }_{- ∞}^{∞} {\vert \frac{A ( Dz )}{A ( 0 )} \vert}^{2} Q ( z ) d z = \frac{1}{2 {π}^{2}} {\int }_{- ∞}^{∞} {\vert \frac{A ( Dz )}{A ( 0 )} \vert}^{2} ( \frac{1 - Sin c ( 4 π z )}{{z}^{2}} ) d z \qquad [ Formula 15 ]$$

Here, z=x/D and z refers to the coordinate of screen in parallel with a scanning direction. D=2λa/Δ and D refers to the size of a resolving factor of the human eye on the screen. a refers to the distance between the screen and the human eye, and Δ refers to the size of crystal lens corresponding to the human eye.

While the formula 15 can be acquired from scalar approach, the depolarization of screen results in the reduced constrast ratio. An ideal coherent beam of light polarized after being scattered from a rough surface may completely lose the polarization. The scattered beam of light can be typically formed to include two non-correlated orthogonal polarized components. The two polarized components can statistically generate two independent speckle patterns. In spite of no diffuser and no scanning, the overall speckle constrast ratio may be required to be \sqrt{2} times as small as that of the formula 15. Accordingly, the actual speckle constrast ratio can be reevaluated by the following formula 16.

$${C}^{2} = 2 {\int }_{- ∞}^{∞} {\vert \frac{A ( Dz )}{A ( 0 )} \vert}^{2} Q ( z ) d z = \frac{1}{4 {π}^{2}} {\int }_{- ∞}^{∞} {\vert \frac{A ( Dz )}{A ( 0 )} \vert}^{2} ( \frac{1 - Sin c ( 4 π z )}{{z}^{2}} ) d z \qquad [ Formula 16 ]$$

The sepckle constrast ratio can be represented as the function of Q(z) and A(Dz)/A(0). In the formula 15, the decreased integral value can acquired by the descrease of the squared value in the curve A(Dz)/A(0). The maximum value may be 1, and it may be required to narrow the central peak w and to reduce the side lobe level As in order to decrease the squared value. In other words, it is possible to make the speckle contrast ratio from the formula 16 by the satisfying the formulas 3 and 4.

Ideally, the autocorrelation function of the formula 5 can approximate to the Dirac-delta function. In other words, A(x)≈δ(x). In this case, the speckle contrast ratio of the formula 15 can be nearly close to zero, and the speckle can be completely reduced.

The formulas 3 and 4 can be evaluated by using a Barker code. The autocorrelation function of the Barker code, which has the very small side lobe level and the narrow central peak, can be closest to the Dirac-delta function. More numbers of Barker codes can be closer to the Dirac-delta function.

The Barker code sequence pattern, which is the non-correlated sequence pattern having the maximum 13 length, can be generated by the formula 18. The formula 17 shows an example of a Barker code.

$$\begin{matrix}B = [ 1 \; 1 \; 1 \; 1 \; 1 - 1 - 1 \; 1 \; 1 - 1 \; 1 - 1 \; 1 ] & [ Formula 17 ] \\ H ( x ) = {\sum }_{i = 0}^{N - 1} {B}_{i} \cdot rect ( \frac{N}{T} x - i ) & [ Formula 18 ]\end{matrix}$$

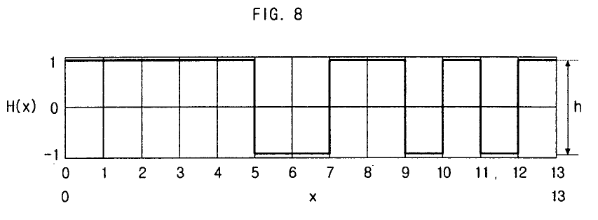

Here, rect(x−i) has 1 only in sections between i and I+1 and 0 in other sections. N(N=13) refers to the length of Barker code. FIG. 8 shows the Barker code sequence pattern acquired by the formulas 17 and 18.

In the formula 17, the positive sign indicates a first relative phase shift of 0 radian, and the negative sign indicates a second relative phase shift of π radian, or vice versa. The depth (or height) of the Barker code sequence pattern may be required to satisfy the following formula 19.

h=λ/2(n₀−1) [Formula 19]

Here, n₀ refers to the refraction index of the light transmissive substrate 710.

The phase control pattern 720 of FIG. 7 is h·H(x). The overall length of the phase control pattern 720 of the formula 18 may be required to be equal to the single pixel size in the X-axis direction or the beam width T in the optical modulator 405. The phase control pattern 720 can be repeated in the X axis direction in order to prevent the beam from being in discord with the phase control pattern 720.

The pattern of the formula 18 can feature the autocorrelation function having the narrow central peak (which is nearly identical to a single bit or pitch (T/N)) and the low side lobe level. This can indicate that the pattern after being shifted in the X-axis direction as long as Δx (Δx≧T/N) that is identical to or more than the single pitch (T/N).

The non-correlated speckle pattern can be superposed by using the Barker code sequence pattern of FIG. 8 as the phase control pattern 720, to thereby reduce the laser pattern. In the embodiment, since the Barker code seqquence pattern has the length of 13, the speckle reducing factor can be \sqrt{13} at the minimum. However, the length of the Barker code sequence may be limited to 13 at the minimum.

Accordingly, the present invention can use the compound Barker code sequence generated from the basic Barker code sequence by the following formula 20.

$${H}_{n , m} ( x ) = {\sum }_{i} {H}_{n} ( x - i χ n ) {H}_{m} ( i χ m ) \qquad [ Formula 20 ]$$

Here, H_{n,m}(x) refers to a binary function indicating a new compound Barker code sequence. Hₙ(x) and Hₘ(x) refer to functions defining bagic Barker code sequences having the lengths of n and m, respectively, as shown in the formula 21. χ refers to the size of Barker code chip.

$${H}_{n} ( x ) = {\sum }_{i}^{n} {b}_{i}^{n} rect ( \frac{x - i χ}{χ} ) , {H}_{m} ( x ) = {\sum }_{i}^{m} {b}_{i}^{m} rect ( \frac{x - i χ}{χ} ) \qquad [ Formula 21 ]$$

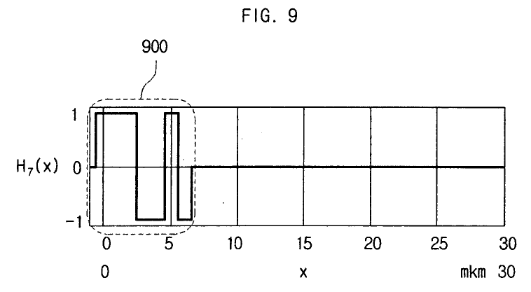

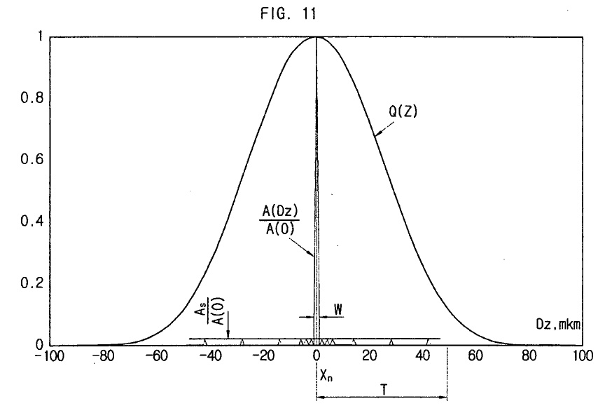

bᵢⁿ and bᵢ^{m} refer to components of the basic Barker code sequences having n and m, respectively. In this case, the compound Barker code sequence can have the very long length of N (N=n×m). The autocorrelation function of compound Barker code sequence can the narrower central peak (about 1/·m) and the relatively small side lobe. The compounding method will be described below with reference to FIG. 9 and FIG. 11.

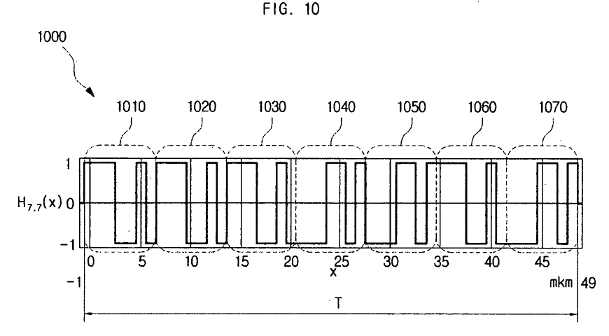

FIG. 9 shows a basic Barker code sequence having the length of 7, and FIG. 10 shows a compound Barker code sequence having the length of 7×7. FIG. 11 is a square mosule graph of a autocorrelation function of a compound Barker code sequence having the length of 7×7.

The basic Baker code sequence H₇(x) 900 having the length of 7 and the component vector [11 1 −1 −1 1 −1] is illustrated in FIG. 9.

In FIG. 10, the compound Barker code sequence H_{7,7}(x) 1000 to which the basic Barker code sequence 900 of FIG. 9 is compounded by the formula 20. The compound Barker code sequence 1000 can be formed to include 7 sub_Barker code sequences 1010 through 1070. Each sub_Barker code sequence 1010 through 1070 may be identical to the basic Barker code sequence 900 of FIG. 9 or may have the opposite phases to the basic Barker code sequence 900 of FIG. 9.

In case that the component vector of the basic Baker code sequence 900 has the component of 1, the compound Barker code sequence 1000 can be compounded by using the sub_Baker code sequences 1010, 1020, 1030 and 1060 that have the same phases as the basic Baker code sequence 900. In case that the component vector of the basic Baker code sequence 900 has the component of −1, the compound Barker code sequence 1000 can be compounded by using the sub_Baker code sequences 1040, 1050 and 1070 that have the opposite phases to the basic Baker code sequence 900. Accordingly, the compound Barker code sequence 1000 can have the length of 49 (7×7).

FIG. 11 shows the autocorrelation functions A(Dz)/A(0) and Q(z).

Below is the remaining speckle constrast ratio computed by the formula 16.

(i) In the case of uniformly emitting a beam on a depolarization screen, C=1/\sqrt{2}=0.701 or 70%,

(ii) In case that a rectangular shaped beam (n=1) is scanned, C=0.424 or 42%,

(iii) In case that a basic Barker code shaped beam is scanned (n=7), C=0.181 or 18%,

(iv) In case that a basic Barker code shaped beam is scanned (n=13), C=0.131 or 13%,

(v) In case that a compound Barker code shaped beam is scanned (n×m=7×7), C=0.072 or 7%,

(v) In case that a compound Barker code shaped beam is scanned (n×m=7×11), C=0.057 or 5%.

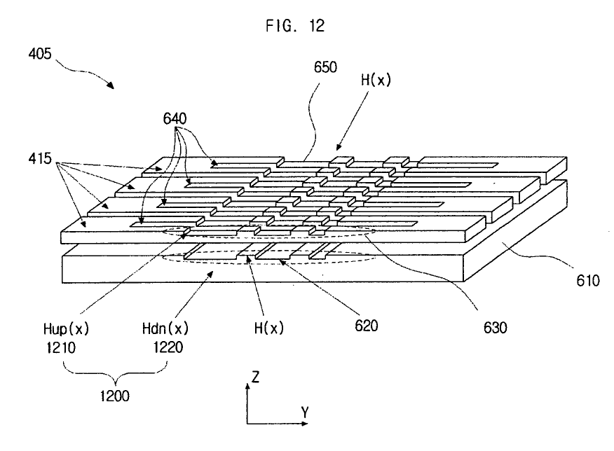

FIG. 12 is a perspective view showing an optical modulator having a phase control pattern in accordance with another embodiment of the present invention.

Each ribbon 415 of the optical modulator 405 can be formed with slits 640. A first phase control pattern Hup(x) 1210 can be formed in a center part 630 of each ribbon 415, which is an upper mirror 650. Also, a second control pattern Hdn(x) 1220 can be formed in a surface of the insulation layer 610 which the lower mirror 620 is formed.

The first phase control pattern Hup(x) 1210 can be identical to the second control pattern Hdn(x) 1220. The pattern 1210 or 1220 can use the compound Barker code sequence as shown in FIG. 10. Also, the pattern 1210 or 1220 can be engraved in a depressed form (refer to FIG. 12) or in an embossed form.

Also, in case that no slit 640 is formed in each ribbon 415 of the optical modulator 405, the first phase control pattern 1210 can be formed the upper mirror 650 of each ribbon 415. In this case, the gray scale of one pixel can be represented by using at least two ribbons 415.

Since the phase control pattern 1200 can be formed in the surface of the ribbon 415 of the optical modulator 405 in any cases (i.e. z₀=0), the formula 1 can be always satisfied. Here, the depth (or height) of the first phase control pattern 1210 and/or the second phase control pattern 1220 can be λ/4 (the reflection type of phase shift).

As described above, the phase control pattern can be formed in a surface of the light transmissive substrate 710 or the ribbon 415 of the optical modulator. An outputted beam of light, which was a one-dimensional linear beam of light, can be scattered into a two-dimensional spatial beam of light in the projection optical system 407. Again, the two-dimensional spatial beam of light can be concentrated as a one-dimensional linear beam of light by the projection lens 408, and transferred to the screen 411 by the scanning mirror 410.

A beam of light scanned on a screen can be transferred to a human eye resolution area and have the phase control pattern as shown in FIG. 10. If all designs are assumed to be accurate, the beam width may be identical to the size of human eye resolution area. Whenever the beam of light is shifted as much as the pitch M×T/N (M refers to the magnification of a screen), a new non correlated random intensity can be generated for the human eye. The total number of new non correlated random intensity can be identical to N (i.e. the length of compound Barker code sequence, n×m).

As a result, the N-time averaged intensity level can be generated in the human eye. These operations can be repeated for the overall screen. The general speckle contrast ratio can be reduced \sqrt{N} times. The whole size of display apparatus can be reduced by forming the kind of phase control pattern in the optical modulator 405 directly or in the optical modulator module 700.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. An optical modulator module, comprising:
an optical modulator, modulating an incident beam of light incident according to a driving signal and outputting the modulated beam of light; and
a light transmissive substrate, placed in the optical modulator and formed with a phase control pattern, the incident beam of light and the outputted beam of light passing through the light transmissive substrate and the phase control pattern being formed in a part of a surface that is a light path of the incident beam of light and the outputted beam of light,
whereas, in the phase control pattern, a central peak of an autocorrelation function has a width w that is smaller than a width T of the phase control pattern, and a side lobe level Aₛ is smaller than a level A(0) of the central peak.

2. The module of claim 1, wherein the phase control pattern satisfies formulas |Aₛ/A(0)|²<<1 and w/T<<1.

3. The module of claim 1, wherein the phase control pattern is engraved in an embossed form with a height of compound Barker code sequence pattern.

4. The module of claim 1, wherein the phase control pattern is engraved in a depressed form with a depth of compound Barker code sequence pattern.

5. The module of claim 1, wherein the phase control pattern induces a relative phase shift of zero radian or π radian.

6. An optical modulator, comprising:
a substrate;
an insulation layer, placed in the substrate;
a structure layer, having a center part which is placed away from the insulation layer at a predetermined interval, and having a surface in which an upper mirror is formed, a first phase control pattern being formed in the center part; and
a piezoelectric driving element, placed in opposite side parts of the structure layer and allowing the center part of the structure layer to move up and down,
whereas, in the first phase control pattern, a central peak of an autocorrelation function has a width w that is smaller than a width T of the phase control pattern, and a side lobe level Aₛ is smaller than a level A(0) of the central peak.

7. The optical modulator of claim 6, wherein the first phase control pattern satisfies formulas |Aₛ/A(0)|²<<1 and w/T<<1.

8. The optical modulator of claim 6, wherein the first phase control pattern is engraved in an embossed form with a height of compound Barker code sequence pattern.

9. The optical modulator of claim 6, wherein the first phase control pattern is engraved in a depressed form with a depth of compound Barker code sequence pattern.

10. The optical modulator of claim 6, wherein the first phase control pattern induces a relative phase shift of zero radian or π radian.

11. The optical modulator of claim 6, wherein at least one slit is formed in a lengthwise direction at the center part of the structure layer, and
the insulation layer has a surface in which a lower mirror is formed and a second phase control pattern is formed at a lower part of the first phase control pattern.

12. The optical modulator of claim 11, wherein, in the second phase control pattern, a central peak of an autocorrelation function has a width w that is smaller than a width T of the phase control pattern, and a side lobe level Aₛ is smaller than a level A(0) of the central peak.

13. The optical modulator of claim 12, wherein the second phase control pattern satisfies formulas |Aₛ/A(0)|²<<1 and w/T<<1.

14. The optical modulator of claim 11, wherein the second phase control pattern is engraved in an embossed form with a height of compound Barker code sequence pattern.

15. The optical modulator of claim 11, wherein the second phase control pattern is engraved in a depressed form with a depth of compound Barker code sequence pattern.

16. The optical modulator of claim 11, wherein the second phase control pattern induces a relative phase shift of zero radian or π radian.

17. The optical modulator of claim 11, wherein the first phase control pattern and the second phase control pattern have identical shapes.

18. A scanning display apparatus comprising:
a light source, emitting an incident beam of light;
an optical modulator module, modulating the incident beam of light and outputting the modulated beam of light; and
a scanning mirror, scanning the outputted beam of light on a screen,
wherein the optical modulator module comprises a light transmissive substrate, placed in the optical modulator and formed with a phase control pattern, the incident beam of light and the outputted beam of light passing through the light transmissive substrate and the phase control pattern being formed in a part of a surface that is a light path of the incident beam of light and the outputted beam of light,
whereas, in the phase control pattern, a central peak of an autocorrelation function has a width w that is smaller than a width T of the phase control pattern, and a side lobe level Aₛ is smaller than a level A(0) of the central peak.

19. A scanning display apparatus comprising:
a light source, emitting an incident beam of light;
an optical modulator module, modulating the incident beam of light and outputting the modulated beam of light; and
a scanning mirror, scanning the outputted beam of light on a screen,
wherein an optical modulator comprises
a substrate;
an insulation layer, placed in the substrate;
a structure layer, having a center part which is placed away from the insulation layer at a predetermined interval, and having a surface in which an upper mirror is formed, a first phase control pattern being formed in the center part; and
a piezoelectric driving element, placed in opposite side parts of the structure layer and allowing the center part of the structure layer to move up and down,
whereas, in the first phase control pattern, a central peak of an autocorrelation function has a width w that is smaller than a width T of the phase control pattern, and a side lobe level Aₛ is smaller than a level A(0) of the central peak.
